(19) United States
(12) Patent Application Publication
(10) Pub. No.: US 2025/0375644 A1
(43) Pub. Date: Dec. 11, 2025

(54) INSENSITIVE SOLID-STATE FIRE SUPPRESSANTS

(71) Applicant: Kidde Technologies Inc., Wilson, NC (US)

(72) Inventors: Paul Papas, West Hartford, CT (US); Lloyd Ballard, Raleigh, NC (US); Adam Chattaway, Windsor (GB)

(21) Appl. No.: 18/739,051

(22) Filed: Jun. 10, 2024

(51) Int. Cl. A62D 1/06; A62D 1/00

(52) U.S. Cl. CPC A62D 1/06; A62D 1/0014

(57) ABSTRACT

A fire suppression system includes a first agent configured as a solid mass. The first agent includes at least one tetrazine-based compound. The at least one tetrazine-based compound comprises a majority by weight of the first agent. The first agent further includes a binder material, and additives. The fire suppression system also includes a circuit with an electrical power source and an initiator. The initiator is electrically connected to the electrical power source and connected to the first agent.

### BACKGROUND

The present disclosure relates generally to fire suppression agents and systems, and more specifically to solid state fire suppression agents.

Many aerospace fire suppressant agents are known, including halon-based agents, foams, inert gas, trifluoromethyl iodide (CF3I), hydrofluorocarbons (HFCs), fluoroketones (FKs), and water mist. Due to ongoing concerns of stratospheric ozone depletion and global warming considerations, production of halons has ceased and production of hydrofluorocarbon-based agents is being tapered. It is therefore desired, and soon may be required, to use non-ozone depleting alternative agents for all new aircraft, and in the future to retrofit older aircraft with such alternative agents.

### SUMMARY

In one aspect of the disclosure, a fire suppression system includes a first agent configured as a solid mass. The first agent includes at least one tetrazine-based compound. The at least one tetrazine-based compound comprises a majority by weight of the first agent. The first agent also includes a binder material. The fire suppression system also includes a circuit. The circuit includes an electrical power source and an initiator. The initiator is electrically connected to the electrical power source and connected to the first agent.

In another aspect of the disclosure, a method is disclosed of activating a fire suppression system to generate inert gas. The method includes igniting a first agent of the fire suppression system to initiate chemical decomposition of the first agent. The first agent is a solid mass that includes a binder and at least one tetrazine-based compound. The tetrazine-based compound forms a majority by weight of the first agent. The method further includes chemically decomposing the first agent to form the inert gas.

In another aspect of the disclosure, a fire suppression system includes at least one container. The at least one container includes a first fire suppression agent and a second fire suppression agent. The first fire suppression agent is a solid-state mass that includes at least one tetrazine-based compound and a binder material. The at least one tetrazine-based compound includes a majority by weight of the first fire suppression agent. The second fire suppression agent is spaced from the first fire suppression agent within the at least one container. The second fire suppression agent is a solid-state chemical agent comprising at least one of sodium bicarbonate, potassium bicarbonate, potassium bromate, and potassium cyanurate hydrate. The fire suppression system further includes a circuit configured to ignite the solid-state mass of the first fire suppression agent.

Persons of ordinary skill in the art will recognize that other aspects and embodiments of the present disclosure are possible in view of the entirety of the present disclosure, including the accompanying FIGURES.

### BRIEF DESCRIPTION OF THE DRAWINGS

FIG. 1 is a schematic illustration of a fire suppression system incorporating a solid-state fire suppression agent and a circuit used to activate the fire suppression agent.

While the above-identified FIGURES set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The FIGURES may not be drawn to scale, and applications and embodiments of the present invention may include features and components not specifically shown in the drawings.

### DETAILED DESCRIPTION

A fire suppression system using a first agent to generate inert gases is disclosed herein. The first agent can include a tetrazine-based compound used as a propellant and a suppressant. A mass of the first agent can be activated using an initiation charge to trigger thermal decomposition of the first agent into inert gases suitable for fire suppression. The fire suppression system can also include a second agent that is decomposed and/or dispersed by the first agent for use as a secondary suppressant. The first agent and the second agent can be incorporated into containers for fixed or portable fire suppression systems. The first agent and the second agent can each be a blend that also includes additives (such as binders, oxidizers, etc.) to optimize gas yield and composition.

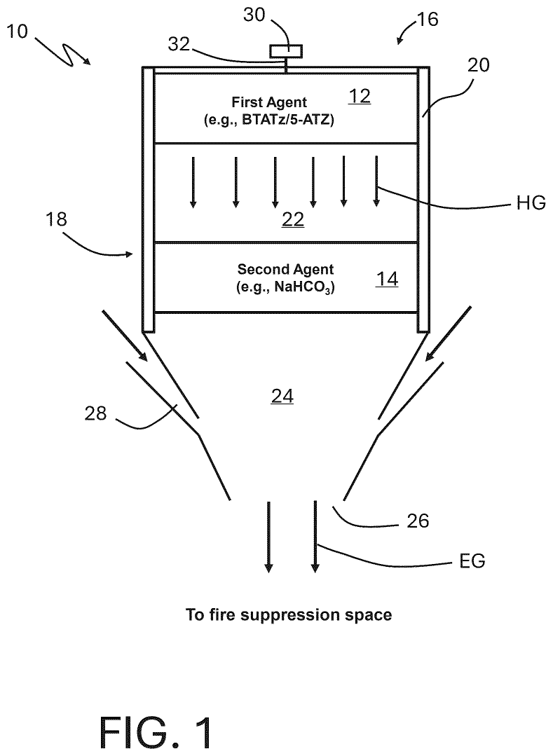

FIG. 1 is a schematic illustration of fire suppression system 10 employing first agent 12 and second agent 14. As shown in FIG. 1, fire suppression system 10 also includes circuit 16 and container 18. Container 18 includes walls 20, chamber 22, nozzle 24, outlet 26, and air mixing apertures 28. Circuit 16 includes electrical power source 30 and initiator 32.

First agent 12 is located inside chamber 22 of container 18 and is connected to initiator 32 of circuit 16. First agent 12 is a fire suppression agent that mostly (majority by weight) comprises a tetrazine-based compound, or a blend of tetrazine-based compounds, in a solid-state form. For example, first agent 12 can include BTATz (3:6-BtS (1H-1,2,3,4-Tetrazol-5-ylamino) 1-2,4,5-tetrazine), or 5-ATZ (5-amino-1H-tetrazole), or a combination of BTATz and 5-ATZ. Both BTATz and 5-ATZ can be decomposed at relatively low temperatures to generate high yields of inert gases. When decomposed, BTATz and 5-ATZ will both yield up to 80% nitrogen gas by weight. First agent 12 can also include a binder to hold the tetrazine-based compound(s) together in a solid mass of a three-dimensional shape (e.g., a cubic or cylindrical block). The binder only forms about 4% by weight of first agent 12 and can include a polymer (such as polyvinyl alcohol—PVA, glycidyl azide polymer—GAP, polyvinyl amine nitrate—PVAN, or polylactic acid-PLA) or a melt cast material.

First agent 12 can include other chemical additives, such as azides and/or melamines (melamine cyanurate), to control a decomposition rate of first agent 12. During decomposition, first agent 12 decomposes mostly to hot nitrogen gas (approximately 80% by weight) with some hydrogen and left over carbon. In some examples, first agent 12 can also include an oxidizer to convert the carbon (or carbon monoxide) into carbon dioxide (CO2), and to convert the hydrogen to water steam. The oxidizer can include potassium nitrate, hydrazine nitrate, potassium bromide, and/or ammonium nitrate. First agent 12 can include near stoichiometric proportions of the tetrazine-based compound(s), binder, additive(s), and/or oxidizer to minimize excess production of undesirable species such as CO. Other binders, additives, and oxidizers are contemplated herein.

First agent 12 can be formed into a solid mass of a three-dimensional shape (e.g., a cubic or cylindrical block). First agent 12 can be classified as a non-sensitive solid material which cannot be detonated by impact or mechanical means. Instead, initiator 32 can start a chemical decomposition of first agent 12 resulting in the formation of hot gases HG. Initiator 32 can be an electric match powered by electrical power source 30 that ignites first agent 12 to start the chemical decomposition of first agent 12. The hot gases HG generated by the decomposition of first agent 12 comprise mostly gaseous nitrogen (N₂), among other byproducts from the decomposition of first agent 12. The hot gases HG are generated within the reaction (i.e., combustion) zone formed within the material of first agent 12.

Second agent 14 is located inside of container 18 and can be spaced from first agent 12 so as not to interfere with the decomposition reactions of first agent 12. In some examples, second agent 14 can be in a second chamber within container 18 that receives the hot gases HG from chamber 22. Second agent 14 is a dry solid-state chemical agent that decomposes through endothermic reactions to generate carbon dioxide and water steam, and other by-products. Second agent 14 is a secondary fire suppressant in fire suppression system 10. For example, second agent 14 can include sodium bicarbonate (NaHCO₃). In other examples, second agent 14 can include potassium bicarbonate or halogenated compounds such as potassium bromate and potassium cyanurate hydrate. Heat from the hot gases HG produced by the decomposition of first agent 12 can be absorbed by second agent 14 to decompose second agent 14 into carbon dioxide and water steam, or other by-products. Because second agent 14 absorbs heat from the hot gases HG, second agent 14 can cool the hot gases HG. Second agent 14 can also oxidize hydrogen and carbon released from the decomposition of first agent 12 into water steam and carbon dioxide. The water steam and carbon dioxide produced from the decomposition of second agent 14 can mix with the hot gases HG (which is mostly nitrogen gas) from first agent 12 to form exiting gases EG. As the exiting gases EG are composed mostly of nitrogen gas, carbon dioxide, and steam, the exiting gases EG are nonflammable and suitable for fire suppression.

In some examples, second agent 14 can be formed into a solid mass positioned within a flow path of the hot gases HG. In this example, second agent 14 remains within container 18 and does not produce particulate emission that can result in dust over the fire suppression space. In other examples, second agent 14 can be stored within container 18 as a powder that is dispersed as a high-momentum solid-state aerosol (such as the sodium bicarbonate aerosol commercially marketed as KSA® by Kidde). When dispersed as a high-momentum solid-state aerosol, second agent 14 can decompose while mixing with the hot gases HG. The decomposition of second agent 14 reduces the gas temperature of the inert hot gases HG through endothermic reactions to generate carbon dioxide and steam as well as oxidize any hydrogen from the decomposition of first agent 12. Any particulate of the aerosolized second agent 14 that does not decompose during the interaction with the hot gases HG can be dispersed to the fire suppression space to decompose in the fire suppression space in the presence of the fire threat to produce carbon dioxide and steam.

Walls 20 of container 18 can include thermal insulation to prevent an exterior surface of container 18 from overheating. In other examples, walls 20 of container 18 can also include a heat absorbing material to help cool the hot gases HG. Container 18 can be portable (i.e., a handheld extinguisher) or fixed in position. Container 18 further includes nozzle 24, outlet 26 and optional air mixing apertures 28 proximate but upstream of outlet 26. In one embodiment, container 18 can be placed in direct flow communication with a fire suppression space (i.e., the space designated as requiring fire suppression from system 10), and in such embodiment, can require no piping or tubing to carry inert gases to another location. In an alternative embodiment, container 18 can be placed within a bulkhead (e.g., of an aircraft) and an intervening container and/or piping can carry inert gases to the fire suppression space. In aircraft, a fire suppression space can be a cargo hold or a gas turbine engine nacelle, to name a few non-limiting examples. In non-aerospace applications, a fire suppression space can be located within a terrestrial or marine vehicle, or a building. Although only one container 18 is shown in FIG. 1, fire suppression system 10 can include multiple containers 18, with each container including first agent 12, second agent 14, circuit 16, nozzle 24, and outlet 26. In an example of fire suppression system 10 with multiple containers 18, containers 18 can be small and modular such that containers 18 can be integrated together to fit into existing spaces on aircraft. A plurality of small and modular containers 18 also allow containers 18 to be selectively activated as needed to “digitally” control the overall pressure rise within the space and target specific locations within the space.

Air mixing apertures 28 can be used to entrain air from the surrounding environment into chamber 22 to mix with and cool inert gases generated from the activation of first agent 12 and second agent 14. Air mixing apertures 28 can have an eductor geometry, as shown in FIG. 1, to facilitate air entrainment, or can have a more cylindrical shape in an alternative embodiment. The number of air mixing apertures disposed within container 18 can be controlled based on the level of cooling needed, without causing too much dilution of the inert gas. In an alternative example, the gases produced by the decomposition of first agent 12 and/or second agent 14 can be cooled by passing them through a heat exchanger (e.g., ceramic honeycomb) to dissipate heat. In another example, the gases produced by the decomposition of first agent 12 and/or second agent 14 can be cooled by mixing them with a liquid agent, such as water, to cool the product decomposition gases through dispersion (e.g., atomization) or heat absorption and/or evaporation of the liquid agent.

The disclosed fire suppression system 10 with first agent 12 and second agent 14 has many benefits over existing agents and systems. Both the first agent 12 and the second agent 14 are non-sensitive solid materials which cannot be detonated by impact or mechanical means, and thus are suitable for aerospace and other vehicular applications. Additionally, the combined weight of first agent 12, second agent 14, and container 18 is relatively low compared to current agents requiring pressurized containers which can reach or exceed 75 lbs. in some cases. The disclosed fire suppression system 10 also does not require any plumbing. Each of the disclosed containers can be lighter and/or more compact than their counterpart containers in a current fire suppression system. The fire suppression system can be scaled up to cover a larger space simply by including additional container units and electrical connections for those units. Finally, the inert gases generated by the disclosed solid-state agents are more environmentally friendly (i.e., having zero ozone depletion potential and global warming impact) than halon and hydrofluorocarbon-based agents, and should not be impacted by future regulatory bans.

### Discussion of Possible Embodiments

In one aspect of the disclosure, a fire suppression system includes a first agent configured as a solid mass. The first agent includes at least one tetrazine-based compound. The at least one tetrazine-based compound comprises a majority by weight of the first agent. The first agent also includes a binder material. The fire suppression system also includes a circuit. The circuit includes an electrical power source and an initiator. The initiator is electrically connected to the electrical power source and connected to the first agent.

The fire suppression system of the preceding paragraph can optionally include, additionally and/or alternatively, any one or more of the following features, configurations and/or additional components in the paragraphs below.

In an embodiment of the foregoing fire suppression system, the first agent comprises at least one of BTATz (3:6-BtS (1H-1,2,3,4-Tetrazol-5-ylamino) 1-2,4,5-tetrazine) and 5-ATZ (5-amino-1H-tetrazole).

In an embodiment of the foregoing fire suppression system, the binder material comprises at least one of polyvinyl alcohol, glycidyl azide polymer, polyvinyl amine nitrate, polylactic acid, and a melt cast material.

In an embodiment of the foregoing fire suppression system, the first agent further comprises: at least one chemical additive comprising at least one of an azide compound and a melamine compound.

In an embodiment of the foregoing fire suppression system, the first agent further comprises: an oxidizer, wherein the oxidizer comprises at least one of potassium nitrate, hydrazine nitrate, potassium bromide, and/or ammonium nitrate.

In an embodiment of the foregoing fire suppression system, the fire suppression system further comprises at least one container having a chamber; and wherein the first agent is disposed within the chamber of the at least one container.

In an embodiment of the foregoing fire suppression system, the at least one container comprises: a nozzle fluidically connected to the chamber; and an outlet on the nozzle, wherein the nozzle fluidically connects the outlet to the chamber, and wherein the outlet is fluidically connected to a fire suppression space.

In an embodiment of the foregoing fire suppression system, the outlet is directly fluidly connected to the fire suppression space, and wherein the at least one container further comprises: a plurality of air mixing apertures extending through the nozzle and fluidically connecting the chamber with ambient air external to the at least one container.

In an embodiment of the foregoing fire suppression system, the fire suppression system further comprises: a second agent inside the at least one container and spaced from the first agent, wherein the second agent is a dry solid-state chemical agent.

In an embodiment of the foregoing fire suppression system, the second agent comprises at least one of sodium bicarbonate, potassium bicarbonate, potassium bromate, and potassium cyanurate hydrate.

In an embodiment of the foregoing fire suppression system, the fire suppression space comprises at least one of an aircraft cargo hold and a gas turbine engine nacelle.

In another aspect of the disclosure, a method is disclosed of activating a fire suppression system to generate inert gas. The method includes igniting a first agent of the fire suppression system to initiate chemical decomposition of the first agent. The first agent is a solid mass that includes a binder and at least one tetrazine-based compound. The tetrazine-based compound forms a majority by weight of the first agent. The method further includes chemically decomposing the first agent to form the inert gas.

The method of the preceding paragraph can optionally include, additionally and/or alternatively, any one or more of the following features, configurations and/or additional components in the paragraphs below.

In an embodiment of the foregoing method, the method further comprises: directing the inert gas into contact with a second agent, wherein the second agent is a solid-state chemical agent comprising at least one of sodium bicarbonate, potassium bicarbonate, potassium bromate, and potassium cyanurate hydrate; and transferring heat from the inert gas into the second agent to decompose the second agent to generate carbon dioxide and water steam.

In an embodiment of the foregoing method, the method further comprises directing the inert gas into contact with the second agent to disperse the second agent as a solid-state aerosol.

In an embodiment of the foregoing method, the method further comprises cooling the inert gas using ambient air.

In another aspect of the disclosure, a fire suppression system includes at least one container. The at least one container includes a first fire suppression agent and a second fire suppression agent. The first fire suppression agent is a solid-state mass that includes at least one tetrazine-based compound and a binder material. The at least one tetrazine-based compound includes a majority by weight of the first fire suppression agent. The second fire suppression agent is spaced from the first fire suppression agent within the at least one container. The second fire suppression agent is a solid-state chemical agent comprising at least one of sodium bicarbonate, potassium bicarbonate, potassium bromate, and potassium cyanurate hydrate. The fire suppression system further includes a circuit configured to ignite the solid-state mass of the first fire suppression agent.

The fire suppression system of the preceding paragraph can optionally include, additionally and/or alternatively, any one or more of the following features, configurations and/or additional components in the paragraphs below.

In an embodiment of the foregoing fire suppression system, the first fire suppression agent comprises at least one of BTATz (3:6-BtS (1H-1,2,3,4-Tetrazol-5-ylamino) 1-2,4,5-tetrazine) and 5-ATZ (5-amino-1H-tetrazole).

In an embodiment of the foregoing fire suppression system, the binder material comprises at least one of polyvinyl alcohol, glycidyl azide polymer, polyvinyl amine nitrate, polylactic acid, and a melt cast material.

In an embodiment of the foregoing fire suppression system, the first fire suppression agent further comprises: at least one chemical additive comprising at least one of an azide compound and a melamine compound.

In an embodiment of the foregoing fire suppression system, the second fire suppression agent is a powder.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fire suppression system comprising:
a first agent configured as a solid mass, the first agent comprising:
at least one tetrazine-based compound, wherein the at least one tetrazine-based compound comprises a majority by weight of the first agent; and
a binder material;
a circuit comprising:
an electrical power source; and
an initiator electrically connected to the electrical power source and connected to the first agent.

2. The fire suppression system of claim 1, wherein the first agent comprises at least one of BTATz (3:6-BtS (1H-1,2,3,4-Tetrazol-5-ylamino) 1-2,4,5-tetrazine) and 5-ATZ (5-amino-1H-tetrazole).

3. The fire suppression system of claim 2, wherein the binder material comprises at least one of polyvinyl alcohol, glycidyl azide polymer, polyvinyl amine nitrate, polylactic acid, and a melt cast material.

4. The fire suppression system of claim 3, wherein the first agent further comprises:
at least one chemical additive comprising at least one of an azide compound and a melamine compound.

5. The fire suppression system of claim 4, wherein the first agent further comprises:
an oxidizer, wherein the oxidizer comprises at least one of potassium nitrate, hydrazine nitrate, potassium bromide, and/or ammonium nitrate.

6. The fire suppression system of claim 4 and further comprising:
at least one container having a chamber; and
wherein the first agent is disposed within the chamber of the at least one container.

7. The fire suppression system of claim 6, wherein the at least one container comprises:
a nozzle fluidically connected to the chamber; and
an outlet on the nozzle, wherein the nozzle fluidically connects the outlet to the chamber, and wherein the outlet is fluidically connected to a fire suppression space.

8. The fire suppression system of claim 7, wherein the outlet is directly fluidly connected to the fire suppression space, and wherein the at least one container further comprises:
a plurality of air mixing apertures extending through the nozzle and fluidically connecting the chamber with ambient air external to the at least one container.

9. The fire suppression system of claim 7, further comprising:
a second agent inside the at least one container and spaced from the first agent, wherein the second agent is a dry solid-state chemical agent.

10. The fire suppression system of claim 9, wherein the second agent comprises at least one of sodium bicarbonate, potassium bicarbonate, potassium bromate, and potassium cyanurate hydrate.

11. The fire suppression system of claim 10, wherein the fire suppression space comprises at least one of an aircraft cargo hold and a gas turbine engine nacelle.

12. A method of activating a fire suppression system to generate inert gas, the method comprising:
igniting a first agent of the fire suppression system to initiate chemical decomposition of the first agent, wherein the first agent is a solid mass comprising a binder and at least one tetrazine-based compound, wherein the tetrazine-based compound forms a majority by weight of the first agent; and
chemically decomposing the first agent to form the inert gas.

13. The method of claim 12, further comprising:
directing the inert gas into contact with a second agent, wherein the second agent is a solid-state chemical agent comprising at least one of sodium bicarbonate, potassium bicarbonate, potassium bromate, and potassium cyanurate hydrate; and
transferring heat from the inert gas into the second agent to decompose the second agent to generate carbon dioxide and water steam.

14. The method of claim 13, further comprising:
directing the inert gas into contact with the second agent to disperse the second agent as a solid-state aerosol.

15. The method of claim 14, and further comprising:
cooling the inert gas using ambient air.

16. A fire suppression system comprising:
at least one container comprising:
a first fire suppression agent, wherein the first fire suppression agent is a solid-state mass comprising:
at least one tetrazine-based compound, wherein the at least one tetrazine-based compound comprises a majority by weight of the first fire suppression agent; and
a binder material; and
a second fire suppression agent, wherein the second fire suppression agent is spaced from the first fire suppression agent within the at least one container, and wherein the second fire suppression agent is a solid-state chemical agent comprising at least one of sodium bicarbonate, potassium bicarbonate, potassium bromate, and potassium cyanurate hydrate; and
a circuit configured to ignite the solid-state mass of the first fire suppression agent.

17. The fire suppression system of claim 16, wherein the first fire suppression agent comprises at least one of BTATz (3:6-BtS (1H-1,2,3,4-Tetrazol-5-ylamino) 1-2,4,5-tetrazine) and 5-ATZ (5-amino-1H-tetrazole).

18. The fire suppression system of claim 17, wherein the binder material comprises at least one of polyvinyl alcohol, glycidyl azide polymer, polyvinyl amine nitrate, polylactic acid, and a melt cast material.

19. The fire suppression system of claim 18, wherein the first fire suppression agent further comprises:
at least one chemical additive comprising at least one of an azide compound and a melamine compound.

20. The fire suppression system of claim 18, wherein the second fire suppression agent is a powder.
